(19) United States
(12) Patent Application Publication
(10) Pub. No.: US 2004/0083493 A1
(43) Pub. Date: Apr. 29, 2004

(54) Transmitting caller ID within a digital stream

(75) Inventors: James L. Swisher, Santa Rosa, CA (US); Steven Sheppard, Sebastopol, CA (US); William Weeks, Westcliffe, CO (US); Douglas A. Penna, Rohnert Park, CA (US); Thomas R. Eames, Penngrove, CA (US); Charles A. Eldering, Doylestown, PA (US)

Correspondence Address: COVINGTON & BURLING, ATTN: PATENT DOCKETING, 1201 PENNSYLVANIA AVENUE, N.W., WASHINGTON, DC, 20004-2401, US

(73) Assignee: NEXT LEVEL COMMUNICATIONS, INC., Rohnert Park, CA

(21) Appl. No.: 10/411,381

(22) Filed: Apr. 11, 2003

Related U.S. Application Data
(63) Continuation-in-part of application No. 09/488,275, filed on Jan. 20, 2000.
Application No. 09/488,275 is a continuation of application No. 09/026,036, filed on Feb. 19, 1998, now Pat. No. 6,317,884.
(60) Provisional application No. 60/038,276, filed on Feb. 19, 1997.

(51) Int. Cl. H04N 11/00; H04N 7/00; H04M 15/06; H04M 1/56; H04N 7/173; H04M 1/64

(52) U.S. Cl. 725/106; 379/88.19; 379/88.21; 379/142.01; 379/142.04; 348/552; 725/133

(57) ABSTRACT

Transmitting caller identification data to residential equipment within a digital transport stream is provided. Telephony signals that include caller identification data are received and the caller identification data is extracted from the telephony signals. The caller identification data in is then embedded the digital transport stream. The digital transport stream, including the caller identification data, is transmitted to residential equipment. The residential equipment extracts the data from the digital stream and presents the caller ID data to a subscriber overlaid on video.

This application is a continuation-in-part (CIP) of, and claims the benefit under 35 U.S.C. § 120 of, co-pending U.S. patent application Ser. No. 09/488,275, filed Jan. 20, 2000, which was a continuation of U.S. patent application Ser. No. 09/026,036 (now abandoned), filed Oct. 12, 1999, which was a continuing prosecution application of U.S. patent application Ser. No. 09/026,036, filed on Feb. 19, 1998, which claimed priority to U.S. provisional patent application No. 60/038,276, filed on Feb. 19, 1997. U.S. patent applications Nos. 09/488,275, 09/026,036, and 60/038,276, are incorporated by reference.

### BACKGROUND OF THE INVENTION

Advances in the field of telecommunications allow large amounts of information to be delivered to a central location, such as a residence, an apartment complex, a business office, etc. (referred to herein simply as location). Digital communications networks (e.g., broadband networks) can provide a location with at least some subset of telephony, video, audio, data, and Internet connectivity. Broadband networks include cable television networks, telephony networks, satellite networks, and terrestrial wireless networks. Within the location, the broadband network can connect to at least some subset of televisions (TV), computers (PC), telephones, and other types of customer premise equipment (CPE). However, as multiple services are being transmitted over the broadband network each of the devices will likely require some type of interface in order to communicate with the broadband network. For example, a set-top box (STB) may be required to convert the digital signals supplied by the broadband network to analog signals compatible with most existing TVs. Moreover, many locations have more than one TV, and would therefore require multiple STBs to receive and convert the digital signals for each TV within the location. An Ethernet bridge/router (EBR) may be required to generate a signal compatible with a computer. A premises interface device (PID) 175 may be required to extract time division multiplexed information and generate a telephone signal.

Requiring separate interface devices for each different device within the location can be expensive as well as inconvenient. Moreover, using separate devices does not allow for cross utilization of the services provided by the broadband network across multiple devices (i.e., displaying on a TV an indication that an email or telephone call is received). Accordingly, there is a need for a single device (e.g., a residential gateway) within the location that can act as a central communications platform between the broadband network and each of the devices within the location. The single device should receive all communications from the broadband network and transmit all communications to the broadband network. The single device should provide the interface between each device and the broadband network. The single device should be capable of providing services normally associated with one device to other devices.

### SUMMARY OF THE INVENTION

The present invention provides a method and system for transmitting a plurality of services, including at least some subset of voice, video, audio and data, to a location over a single medium. Within the residence, a single device (e.g., a residential gateway) is used to provide the interface between the broadband network and each of the devices. The residential gateway allows for cross utilization of the services from one device to another. For example, caller ID data normally associated with a telephone may be presented on a TV or PC. The caller ID is extracted from the telephony signals at some point in the broadband network and transmitted within the digital stream to the RG. The RG extracts the caller ID data from the digital stream and presents it to the subscriber on a front panel of the residential gateway, overlaid over the video presented on the TV, or the data presented on the PC.

### BRIEF DESCRIPTION OF DRAWINGS

The accompanying drawings, which are incorporated in and form a part of the specification, illustrate the embodiments of the present invention and, together with the description serve to explain the principles of the invention.

In the drawings:

FIG. 1 illustrates an exemplary broadband network;

FIG. 2 illustrates exemplary embodiments of three common types of broadband networks;

FIG. 3 illustrates an exemplary Fiber-to-the-Curb (FTTC) broadband network, according to one embodiment;

FIG. 4 illustrates an exemplary digital subscriber line (xDSL) broadband network, according to one embodiment;

FIG. 5 illustrates an exemplary residential gateway, according to one embodiment;

FIG. 6 illustrates an exemplary block diagram of the RG receiving both POTS and xDSL and extracting the caller ID from the POTS within the RG, according to one embodiment;

FIG. 7 illustrates an exemplary block diagram of the caller ID being extracted upstream and provided to the RG within the xDSL digital transport stream, according to one embodiment; and

FIG. 8 illustrates an exemplary BSAM including a caller ID chip for each line card, according to one embodiment.

### DETAILED DESCRIPTION

In describing various embodiments of the invention illustrated in the drawings, specific terminology will be used for the sake of clarity. However, the invention is not intended to be limited to the specific terms so selected, and it is to be understood that each specific term includes all equivalents.

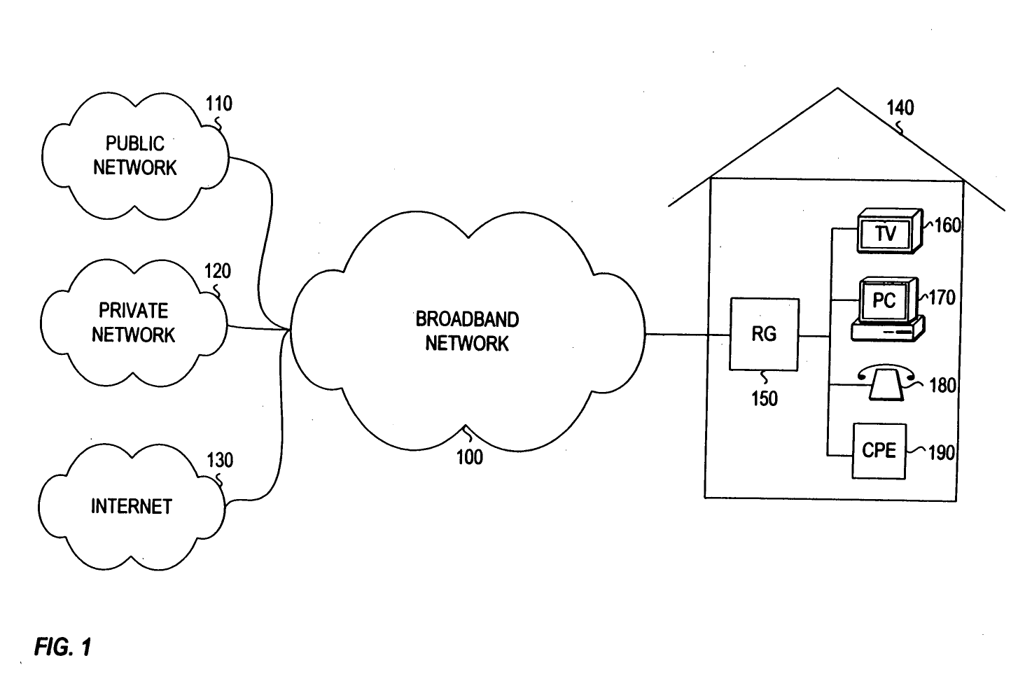

With reference to the drawings, in general, and FIGS. 1 through 8 in particular, the method and apparatus of the present invention are disclosed.

FIG. 1 illustrates an exemplary broadband network 100 connecting public networks 110, private networks 120, and the Internet 130 to multiple devices within a location 140 via a residential gateway (RG) 150. The private and public networks 110 and 120 may include any combination of voice, video, audio and data. The broadband network 100 may be a cable television network, telephony network, satellite network, terrestrial wireless networks, or other type of network that would be obvious to one of ordinary skill in the art in light of this specification. The devices within the location 140 that may connect to the RG 150 include TV 160, PC 170, telephone 180 and other customer premises equipment 190.

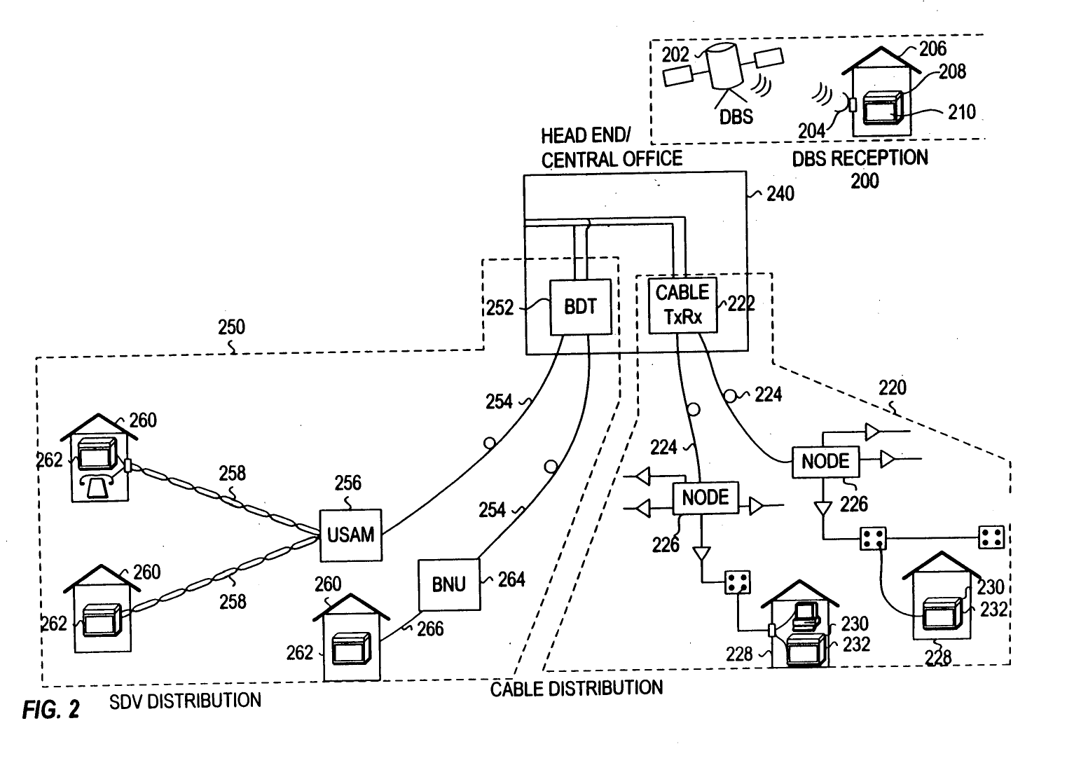

FIG. 2 illustrates exemplary embodiments of three common types of broadband networks: digital broadcast satellite (DBS) 200, cable TV (CTV) 220, and digital subscriber line (XDSL) 250. These networks will be described with regards to video, but are not limited thereto.

The DBS system 200 transmits a programming stream comprising upwards of a hundred channels of television programming directly from a geo-stationary satellite transmitter 202 orbiting the earth to a receiving antenna 204 mounted on or near each subscriber's house 206. The programming stream is transmitted from the antenna via a cable (not shown) to a satellite receiving station 208 in the form of a STB in the subscriber's house 206. The satellite receiving station 208 selects a channel and demodulates the signal for delivery to a monitor 210, such as a television. Most DBS systems 200 are arranged such that data also can be sent in the upstream direction, that is, from the STB 208 to the DBS provider. In most DBS systems 200, the STB 208 also is coupled to the telephone line and is designed and programmed to place telephone calls to the DBS service provider to periodically send information in the upstream direction. Such information commonly may comprise requests for Pay-Per-View (PPV) programs or requests for changes in the subscription (a request that one or more of premium channels be added to the service, etc.).

The CTV network 220, such as a digital cable network, transmits multiple channels of TV information from a head end (or central office) 240 via a cable network 222. Particularly, the channels are transmitted via cables 224, such as fiber optic cables, to nodes 226. The nodes 226 are essentially switching/routing stations that service multiple homes (usually a few hundred). The nodes 226 route the signals to individual subscribers 228. For digital cable, the individual subscribers 228 will have STBs 230 that select a particular channel from the transmit stream, demodulate it and forward it for display on one or more monitors (e.g., televisions) 232. Upstream information may be sent from the STB 230 to the central office 240 via a dedicated upstream channel over the cable. In cable systems that do not support two-way communication, the upstream “channel” can be through the telephone as described above in connection with DBS systems 200.

The xDSL system 250 transmits TV programming over the regular telephone network. Particularly, TV signals are transmitted from a broadband distribution terminal (BDT) 252 within the central office 240 via cables 254, such as fiber optic cables, to a remote terminal (RT) that delivers the data to multiple individual subscriber households 260. According to one embodiment, the RT may deliver the data to the subscribers via regular telephone twisted wire pair 258 using xDSL modems and protocols, in which case the RT may be either a universal service access multiplexer (USAM) or a broadband service access multiplexer (BSAM) 256. The USAM/BSAM 256 receives a wide bandwidth signal comprising some or all of the television channels. However, because of the bandwidth limitations of twisted pair wire, typically only about one to three channels of television programming at a time can be delivered from the USAM/BSAM 256 to the household. Accordingly, the subscriber has a STB 262 that is similar in functionality to the previously discussed STBs for DBS and CTV, except that when the user changes channels such as by operating a remote control, the remote channel change signal is received by the STB 262 and transmitted to the USAM/BSAM 256 which switches the channel for the user and begins sending the newly selected channel to the household. Such systems are known as SDV systems. SDV systems are essentially fully modem asynchronous two-way communication networks. Accordingly, the STB 262 can transmit information upstream via the same xDSL modem that receives the downstream signals. According to one embodiment, SDV systems operate using an asynchronous transfer mode (ATM) protocol that is well known in the networking arts. However, the invention is in no way limited thereto as an Internet Protocol (IP) may be used as well as other protocols that would be apparent to those of ordinary skill in the art in light of this specification.

According to one embodiment, the data may be delivered to the subscribers via coaxial cable 266 using cable modems and protocols, in which case the RT may be a broadband network unit (BNU) 264 or an optical network unit (ONU). In this embodiment, the telephony signals are transmitted to the location separately over twisted wire pair cables. This type of system is often referred to as a Fiber-to-the-Curb (FTTC) system.

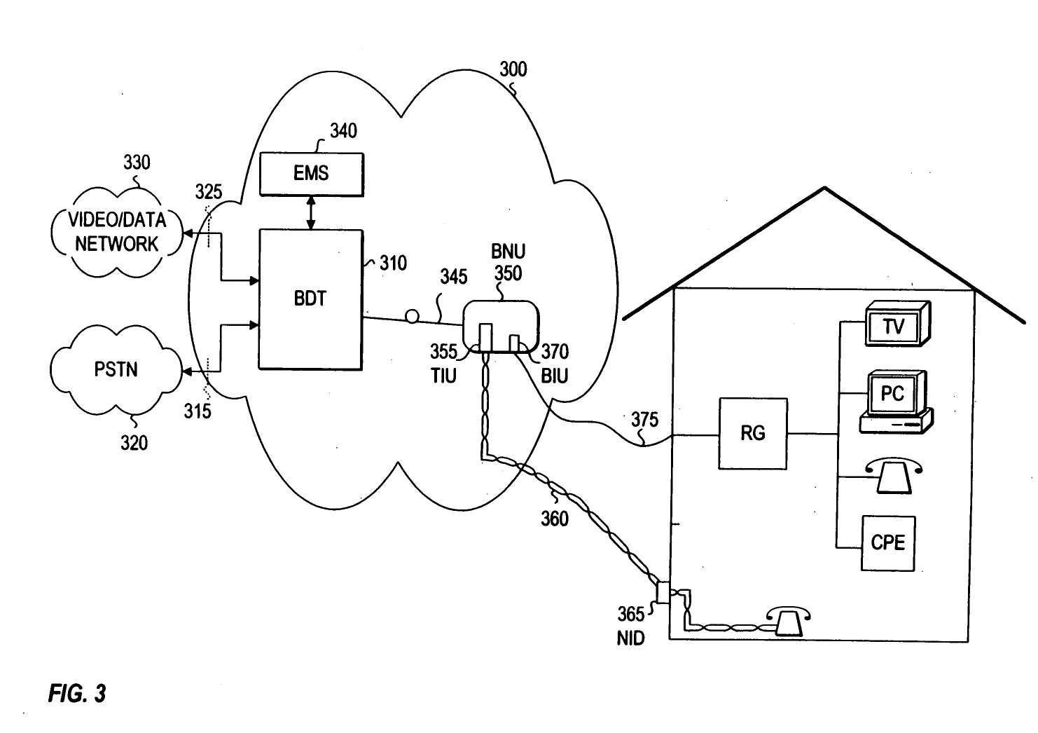

FIG. 3 illustrates an exemplary FTTC broadband network 300. The FTTC broadband network 300 includes a broadband digital terminal (BDT) 310 (also referred to as a host digital terminal (HDT)) connected to the Packet Switch Telephone Network (PSTN) 320. A PSTN-BDT interface 315 is specified by standards bodies, and in the U.S. is specified by Bellcore specifications TR-TSY-000008, TR-NWT-000057 or GR-NWT-000303, which are incorporated herein by reference. The BDT 310 can also receive special service signals from private or non-switched public networks. According to one embodiment, the physical interface to the PSTN 320 may be twisted wire pairs carrying DS-1 signals, or optical fibers carrying Optical Carrier (OC)-3 optical signals.

The BDT 310 is also connected to a Video/Data network (VDN) 330. The VDN 330 may utilize a number of different packetization schemes including, but not limited to, Asynchronous Transfer Mode (ATM), Internet Protocol (IP), and others now known or later discovered. For ease of discussion, this application will simply discuss the preferred embodiment of ATM, but this is in no way intended to limit the invention thereby. An ATM network-BDT interface 325 can be realized using an OC-3c or OC-12c optical interface carrying ATM cells. In a preferred embodiment, the BDT 310 has three OC-12c broadcast ports, which receive signals carrying ATM cells, and one OC-12c interactive port which receives and transmits signals.

An element management system (EMS) 340 is connected to the BDT 310 and forms part of an element management layer (EML) which is used to provision services and equipment on the FTTC network, in the central office where the BDT 310 is located, in the field, or in the locations. The EMS 340 is software based and can be run on a personal computer in which case it will support one BDT 310 and the associated digital network equipment connected to it, or can be run on a workstation to support multiple BDTs 310 and the associated digital network equipment.

Broadband Network Units (BNUs) 350, also referred to as Optical Network Units (ONUs), are located in the serving area and are connected to the BDT 310 via optical fiber 345. For simplicity only one BNU 350 is illustrated. Digital signals, that according to one embodiment have a format that is similar to the Synchronous Digital Hierarchy (SDH) format, are transmitted to and from each BNU 350 over the optical fiber 345 at a rate of at least 155 Mb/s, and preferably 622 Mb/s. In a preferred embodiment, the optical fiber 345 is a single-mode fiber and a dual wavelength transmission scheme is used to communicate between the BNU 350 and the BDT 310. In an alternate embodiment, a single wavelength scheme is used in which low reflectivity components are used to permit transmission and reception on one fiber.

A telephony interface unit (TIU) 355 in the BNU 350 generates an analog plain old telephone signal (POTs), which is transported to the location via a twisted wire pair, drop line cable 360. At the location a network interface device (NID) 365 provides for high-voltage protection and serves as the interface and demarcation point between the twisted wire pair, drop line cable 360 and the internal phone lines. According to one embodiment, the TIU 355 generates POTs signals for six locations, each having a separate twisted wire pair, drop line cable 360 connected to the BNU 350.

A Broadband Interface Unit (BIU) 370 is located in the BNU 350 and generates broadband signals that may contain video, audio, data and voice information. The BIU 370 modulates data onto a RF carrier and transmits the data to the location over media 375, such as a coaxial, drop line cable or a twisted wire pair, drop line cable. In one embodiment, each BDT 310 serves 64 BNUs 350 (32 with redundancy) and each BNU 350 can serve 16 residences. That is, each BNU can support 16×DSL drops and 36 POTS lines. The BNU 350 can serve locations up to approximately 750 feet away. Each xDSL drop can provide 3 video channels and one data feed.

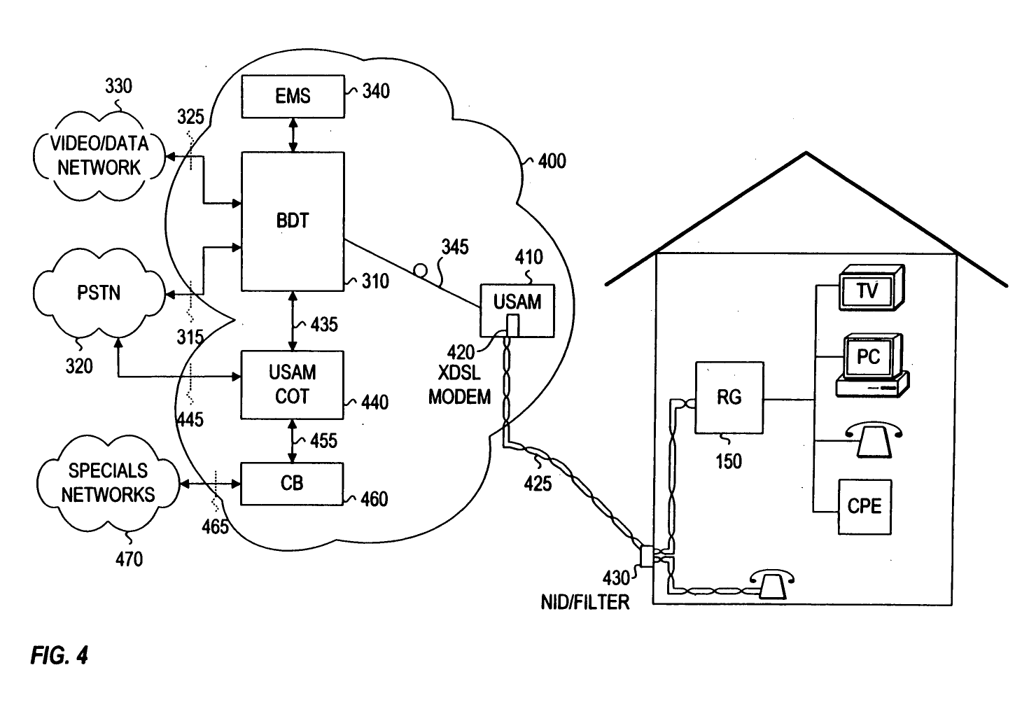

FIG. 4 illustrates an exemplary digital subscriber line (xDSL) broadband network 400. When used herein, the term xDSL refers to any one of the twisted wire pair digital subscriber loop transmission techniques including High Speed Digital Subscriber Loop, Asymmetric Digital Subscriber Loop, Very high speed Digital Subscriber Loop, Rate Adaptive Digital Subscriber Loop, or other similar twisted wire pair transmission techniques. Currently, VDSL and ADSL+ are the preferred configurations used to provide video, audio, data and telephony delivery to the location. In this embodiment, the BNU 350 of FIG. 3 is replaced with a universal service access multiplexer (USAM) 410. It should be noted that the USAM 410 may in fact be a broadband service access multiplexer (BSAM), or a combination USAM/BSAM as will be discussed in more detail later. The USAM 410 is located in the serving area, and is connected to the BDT 310 via optical fiber 345. A twisted wire pair, drop line cable 425 provides communications to and from the location. The USAM 410 includes an xDSL modem 420 that provides for the transmission of high-speed digital data to and from the location, over the twisted wire pair, drop line cable 425. The xDSL modem 420 contains the circuitry and software to generate a signal that can be transmitted over the twisted wire pair, drop line cable 425, and which can receive high-speed digital signals transmitted from the location.

Traditional analog telephone signals are combined with the digital signals for transmission to the location. That is, the analog telephone signals are transmitted at the lower frequency of the twisted wire pair cable 425 and the digital signals are transmitted over the analog telephone signals at a higher frequency. A NID/filter 430 replaces the NID 365 and is used to separate the analog telephone signals from the digital signals. The majority of xDSL transmission techniques leave the analog voice portion of the spectrum (from approximately 400 Hz to 4,000 Hz) undisturbed. The analog telephone signal, once separated from any digital data signals in the spectrum, is sent to a telephone over internal twisted wire pairs. The digital signals that are separated at the NID/filter 430 are sent from a separate port on the NID/filter 430 to the RG 150.

The xDSL broadband network 400 may also include a USAM Central Office Terminal (COT) 440 that is connected to the BDT 310 via a USAM COT-BDT connection 435, which according to one embodiment is a twisted wire pair that transmits an STS3c signal. A PSTNUSAM COT interface 445 is one of the Bellcore specified interfaces including TR-TSY-000008, TR-NWT-000057 or TR-NWT-000303, which are all incorporated herein by reference. The USAM COT 440 has the same mechanical configuration as the USAM 410 in terms of power supplies and common control cards, but has line cards which support twisted wire pair interfaces to the PSTN 320 (including DS-1 interfaces) and cards which support STS3c transmission over the twisted wire pair of the USAM COT-BDT connection 435. A Channel Bank (CB) 460 in the central office is used to connect special networks 470, comprised of signals from special private or public networks, to the xDSL broadband network 400 via a special networks-CB interface 465. In a preferred embodiment, a CB-USAM COT connection 455 includes DS1 signals over twisted wire pairs.

The USAM 410 (or the USAM COT 440) can support ADSL, ADSL+, or VDSL configurations. The ADSL configuration can support telephony, narrowband and data services at distances between 12,000 to 18,000 feet. The data service is overlaid over POTS (telephony). That is, the data utilizes the frequency spectrum above the frequency spectrum utilized by the POTS. Narrowband services may include Centrex, PBX, 800 services, ISDN, COIN and other services that would be apparent to one of ordinary skill in the art in light of this specification. The ADSL+ configuration can support up to 10 Mbps of bandwidth to subscribers at distances of up to 10,000 feet. This bandwidth can be used to deliver robust voice services, 1.5 Mbps of high-speed data, two streams of DVD quality digital video, and a full suite of interactive applications including video on demand (VoD), web access environments (“walled gardens”), chat, email, and interactive gaming. The VDSL configuration can support up to 26 Mbps of bandwidth at distances between 3,000 to 4,000 feet. This bandwidth can be used to provide 3 video channels, up to 7 Mbps for high speed Internet access and full service digital loop carrier (DLC).

According to one embodiment, the USAM 410 (or the USAM COT 440) can host 16 line cards per shelf, where the cards can be any mix of DLC, ADSL, ADSL+, and VDSL line cards. Each line card can support 6 POTS lines, each ADSL or ADSL+ card can support 3 ADSL or ADSL+ circuits, and each VDSL card can support 2 VDSL circuits. Accordingly, there is a maximum per shelf of 96 POTS lines, 48 ADSL or ADSL+ circuits, and 32 VDSL circuits.

As previously mentioned the USAM 410 may be replaced by a BSAM. BSAMs are used in areas that are more densely populated and require additional broadband capabilities. Each BSAM can support 12 line cards and each line card can support 12 circuits so that the BSAM supports 144 xDSL lines per shelf. In one embodiment, the BSAM is designed to solely support broadband services such as video and data, and does not support the narrow band services (i.e., PBX, ISDN, 800 service). The BSAM may utilize VDSL line cards or ADSL+ line cards. An ADSL+ BSAM configuration can support up to 10 Mbps of bandwidth to subscribers at distances of up to 10,000 feet to deliver 1.5 Mbps of high-speed data, two streams of DVD quality digital video, and a full suite of interactive applications including video on demand (VoD), web access environments (“walled gardens”), chat, email, and interactive gaming. The VDSL BSAM configuration can support up to 26 Mbps of bandwidth at distances between 3,000 to 4,000 feet to provide 3 video channels and up to 7 Mbps for high speed Internet access.

If the area requires narrowband services as well as broadband services a USAM can be daisy chained to the BSAM in order to provide the narrowband services. In environments that have a minimal number of users a USAM single shelf enclosure (USAM-SSE) can be utilized in existing cabinets of equipment. The USAM SSE supports all the functions described above with respect to the USAM except that it is limited to a single shelf.

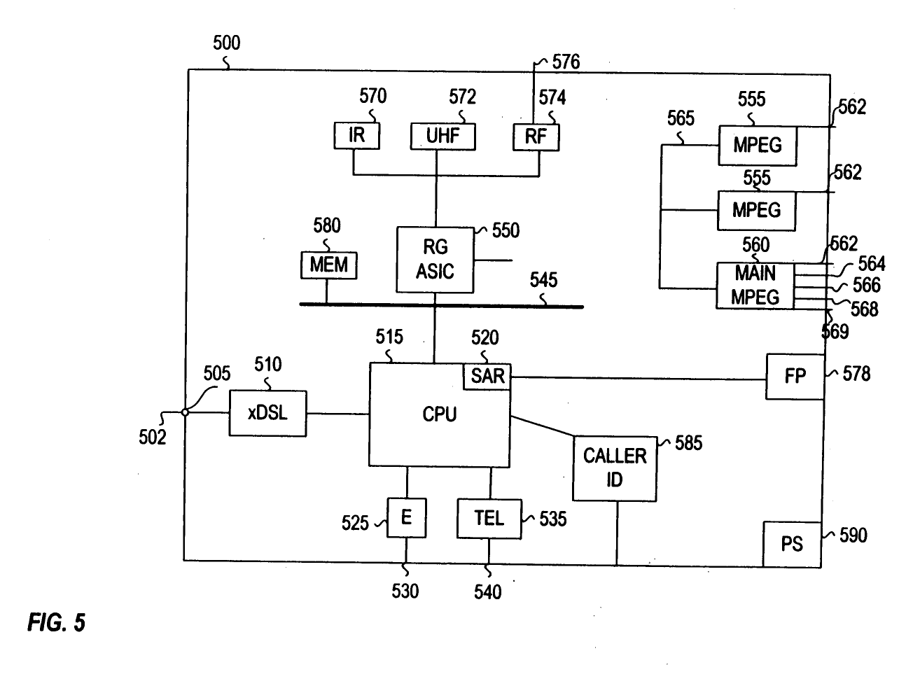

FIG. 5 illustrates an exemplary residential gateway (RG) 500. The RG 500 connects to the broadband network via a network input 505 (e.g., a RJ-45 connector) and network interface module (NIM) (e.g., a xDSL modem 510 for connecting to an xDSL broadband network). The broadband network can be any broadband network now known or later discovered by those of ordinary skill in the art and the network input 505 and the NIM 510 would accordingly be associated therewith. According to one embodiment, the RG 500 communicates with the broadband network by using an ATM transport over an xDSL link. However, this embodiment should in no way be construed to limit the invention thereby. As previously mentioned, the packetization transport layer could be ATM, IP, or any other now known or later discover protocol. Again for ease of discussion, ATM will be discussed throughout the specification.

The xDSL modem 510 performs the demodulation of the signal and other processing to generate a signal destined to a central processing unit (CPU) 515. The CPU 515 contains a Segmentation Assembly and Re-assembly (SAR) unit 520 that processes the ATM cells transported in the xDSL link 502. The SAR 520 constructs ATM cells from the ATM stream received from the xDSL modem 510. In addition to constructing the ATM cells, the SAR 520 can reduce jitter in the ATM cells that arises from transmission of those cells over the ATM network. As previously discussed the broadband network may deliver some combination of voice, data, and video to the location.

If the ATM cells contain Ethernet frames destined for PCs (i.e., data), then the CPU 515 extracts the Ethernet data and transmits that data to an Ethernet interface 525. The Ethernet interface 525 provides the interface between the PC (or LAN of PCs and peripheral equipment) and the broadband network via the RG 500. An Ethernet connector (input/output) 530 provides the connectivity of the RG 500 to the PCs within the location. As illustrated in this embodiment, the Ethernet connection 530 is an RJ-45 connector. This embodiment is in no way intended to limit the scope of the invention. If the ATM cells contain digital telephony signals destined for a telephone the CPU 515 can extract these signals and provide them to a telephony module 535. The telephony module 535 provides the interface between the telephone and the broadband network via the RG 500. The telephony module 535 translates the digital telephony signals to analog signals that are accepted by a conventional telephone and transmits the analog telephony signals via a telephony connector (input/output) 540, such as a standard RJ-11 telephone jack. It should be noted that currently digital telephony requires a lot of signal processing and is thus often not implemented in the RG and the analog telephony service is used instead.

The CPU 515 forwards the remaining ATM cells (video) to a bus 545. The bus 545 is connected to a RG application specific integrated circuit (ASIC) 550. The RG ASIC 550 converts the ATM cells received from the CPU 515 into a suitable video format for decoding. The video data contained in the remaining ATM cells is likely compressed digital video programming. However, it is possible, that the video is analog or a combination of analog and digital. As previously discussed, in one embodiment the digital video data is compressed according to an MPEG standard (currently the MPEG-2 standard). Accordingly, in this embodiment, the RG ASIC 550 converts the ATM cells received from the CPU 515 into MPEG data. Accordingly, the RG 500 needs to have decoders 555 and 560, which in the present embodiment are MPEG decoders to decode (or uncompress) the compressed digital video (MPEG-2 video) into a format that is understood by televisions.

In another embodiment, the RG 500 is capable of receiving and decoding more than one digital video stream and providing the appropriate decoded video programming to more than one viewing device (i.e., television, VCR/television). According to one embodiment, the broadband network is a VDSL network that is currently capable of transmitting three separate video streams to a location and accordingly the RG 500 is capable of decoding three separate digital streams and has three separate video decoders. According to another embodiment, the broadband network is an ADSL+ network capable of transmitting two separate video presentations per location and thus the RG 500 is capable of decoding two separate video streams and has two separate video decoders. Of course the invention is in no way intended to be limited to the above examples of different types of broadband networks or the number of video stream each broadband network can support. The exemplary embodiment illustrated in FIG. 5 has three separate MPEG decoders: two MPEG decoders 555 and a main MPEG decoder 560. The decoders will be discussed in more detail later.

According to one embodiment of the invention, a bus 565 coupling the RG ASIC 550 to each of the MPEG decoders 555 and 560 comprises an MPEG transport and an oversampled (OS) link. The MPEG transport includes data, packet clock and bit clock lines. The OS link is a control data bus that includes data in and data out lines. The OS link provides a communication path between the CPU 515 and the MPEG decoders 555 and 560 by way of the RG ASIC 550. The CPU 515 controls the operation of the decoders 555 and 560 by providing each decoder 555 and 560 with control signals via the OS link indicating, for example, when the decoder 555 and 560 should start decoding, stop decoding, and what video data to output.

As illustrated in FIG. 5, the MPEG decoders 555 produce a radio frequency (RF) audio/video (A/V) output that is modulated to a display device (i.e., TV) via output 562, such as a coaxial cable output. The MPEG decoder 555 may be a single unit capable of decoding both digital video and digital audio and modulating the signals, may be a compilation of components including a video decoder, an audio decoder and a modulator, or may be some combination thereof. Regardless of whether the MPEG decoder 555 is a single unit or a compilation of parts, the decoded A/V output is modulated onto carriers to produce broadcast type signals compatible with standard televisions and transmitted to display devices. As illustrated in FIG. 5, the main MPEG decoder 560 may provide separate video (S-Video) 564 and composite video 566 outputs to a display device to which it is connected. As is apparent to those skilled in the art in view of this specification, the S-Video 564 and composite video 566 outputs are sent to the display device without being modulated. Moreover, the main MPEG processor 560 may also provide a separate audio output 568 and an AC-5 output 569.

According to one embodiment, the display devices (i.e., TVs, VCRs, PVRs) are controlled by the RG 500 and according the remote controls (not illustrated) for each device are actually communicating with the RG 500. Thus, the RG 500 includes an infrared (IR) receiver 570 and an ultra high frequency (UHF) receiver 572 that receive inputs from a user or users. The IR receiver and the UHF receiver are coupled to the RG ASIC 550. The commands received by the IR receiver 570 are commands from an IR remote control (not illustrated) and the commands received at the UHF receiver 572 are commands from a UHF remote control (not illustrated). As one skilled in the art would recognize in light of this specification, the user commands can include power on/off, volume changes, channel changes, electronic program guide (EPG) activation, fast-forward/rewind commands for prerecorded media, video on demand (VoD) selections, etc. For purposes of this application we will concentrate on channel changes, as these commands need to be sent to the broadband network for processing. The IR receiver 570 and/or UHF receiver 572 convert their respectively received analog signals into digital signals and transmit the digital signals to the RG ASIC 550 that in turn communicates the commands to the CPU 515. Alternatively, the user may communicate with the RG 500 via a front panel interface 578 either in conjunction with or in place of the remote control devices. The commands received via the front panel interface 578 are transmitted to the CPU 515 for processing.

As one skilled in the art would recognize, the IR remote control has limited range (i.e., needs a direct path between IR remote and the IR receiver 570) so that it is likely that a display device in close proximity (e.g., same room) as the RG 500 utilizes an IR remote. UHF remote has a greater range than an IR remote and may therefore be able to be used for devices that are not in the same room as the RG 500 (e.g., adjacent rooms). However, the range of the UHF remote and UHF receiver 572 is also limited (due to numerous obstacles within a location, and the fact that it would be counter intuitive to point a remote toward an RG in a separate room as opposed to the TV in that room). Due to the limitations of the IR receiver 570 and the UHF receiver 572, the RG 500 also includes an RF module 574 that is capable of processing channel change commands that are received via an RF signal. This type of setup is used for display devices that are remotely located from the RG (i.e., separate floor) where use of and IR or UHF remote transmitting channel changes to the RG is not an option.

According to one embodiment, the user interacting with a remotely located TV uses an IR remote. Connected to the remotely located TV is a device (e.g., an optical conversion device) that can receive an IR signal from the IR remote and convert the signal to an RF signal that can be transmitted to the RG via a coaxial cable that was used to transmit the video from the RG 500 to the TV. A device is required to extract the channel change command from the coaxial cable and provide the signal to the RG. According to one embodiment, a remote antennae module extracts the channel change command from the coaxial cable and provides the command to the RF module via an input 576. According to a preferred embodiment, the input 576 is a standard speaker connector. The use of the optical conversion device and remote antennae module for transmitting channel changes signals from remotely located televisions is disclosed in more detail in co-pending patent application Ser. No. 09/526,100, filed on Mar. 15, 2000, entitled “Optical Conversion Device,” which is herein incorporated by reference in its entirety but is not admitted to be prior art.

According to another embodiment, the user interacting with a remotely located TV uses a UHF remote. Connected to the remotely located TV is a device that can receive a UHF signal from the UHF remote (a remote antennae package) that can be transmitted to the RG via a coaxial cable that was used to transmit the video from the RG 500 to the TV. As with the above-mentioned embodiment, a remote antennae module extracts the channel change command from the coaxial cable and provides the command to the RF module via an input 576 (preferred embodiment is a standard speaker connector). The use of the remote antennae package and remote antennae module for transmitting channel changes signals from remotely located televisions is disclosed in more detail in co-pending patent application Ser. No. 09/525/488, filed Mar. 15, 2000, entitled “Method and Apparatus for Transmitting Wireless Signals over a Media”, which is herein incorporated by reference in its entirety but is not admitted to be prior art.

As illustrated, the RG 500 also includes memory 580 attached to the bus 545. The memory may be a single memory unit or may be a compilation of memory units. The memory unit or units may be a hard drive, read access memory (RAM), read only memory (ROM), flash memory, a CD, a RAID, other now know or later discovered forms of memory, or some combination thereof. The memory 580 may be internal, removable, external, or a combination thereof. The memory 580 may be for a variety of reasons, including but not limited to, storing temporary data, processing instructions utilized by the CPU, programming, advertisements, software updates, user preference data, or any other type of data that would be useful or desirable in light of this specification.

The RG 500 includes a power supply 590 for powering the different components of the RG 500 and for converting a 110 VAC to different power levels used by the components in the RG 500.

The RG includes a connector 540, an RJ-11 connector, to connect to the telephony line providing telephony services within the residence. The telephony line may have entered the residence on the same twisted wire pair as the xDSL services and then have been filtered at the NID/Filter 430 or may have come in on a separate twisted wire pair. Regardless, the phone line is provided to the RG so that a caller ID chip (i.e., caller ID extractor) 585 can extract the caller ID information from the telephony signals. The caller ID chip 585 provides the caller ID data to the CPU 515. The CPU 515 may use the caller ID data to display caller ID data, or a message-waiting indicator on a computer, a TV, or on the front panel of the RG 500.

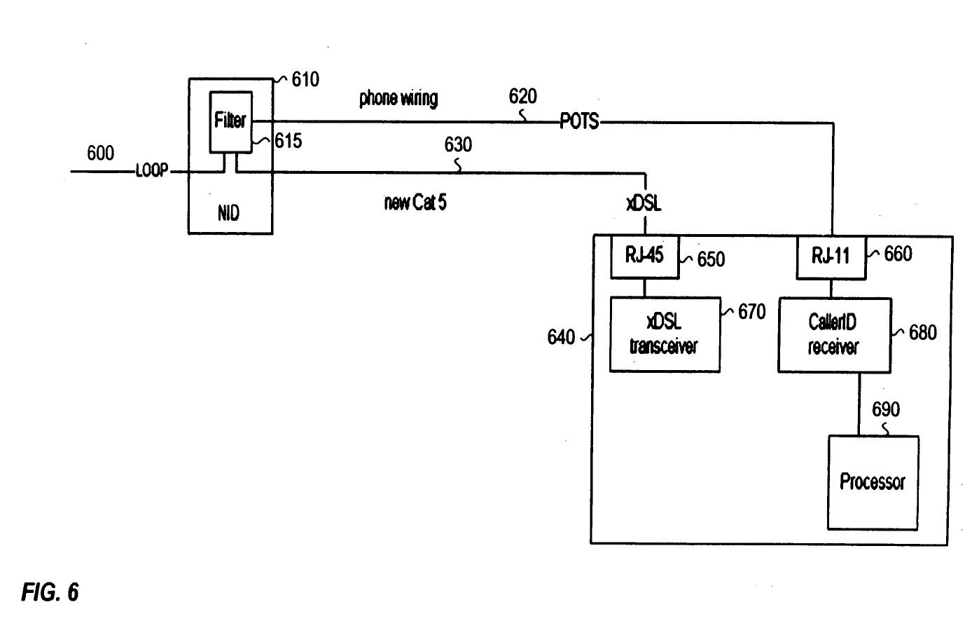

Extracting the caller ID data from the telephony signals within the RG 500 requires that the RG be equipped with a caller ID chip 585 and a telephony port. Moreover, it is necessary to connect the RG to the telephony phone lines. FIG. 6 illustrates an exemplary block diagram of the RG receiving both POTS and xDSL. As illustrated the digital subscriber loop (DSL) 600 containing xDSL over POTS is received by the NID 610 that includes a filter 615. The NID 610 filters (segregates) the POTs and the xDSL services (frequencies) onto two separate lines, phone wiring 620 carrying the POTS signals and new CAT 5 wiring 630 carrying the xDSL services. Each of the lines is received by the RG 640. The xDSL services are received by an RJ-45 650 connector and the POTS services are received by an RJ-11 connector 660. The xDSL services are processed by an xDSL transceiver 670. The POTS signals are received by a caller ID receiver 680 that extracts the caller ID from the POTs line and then provides it to a processor 690 for further processing.

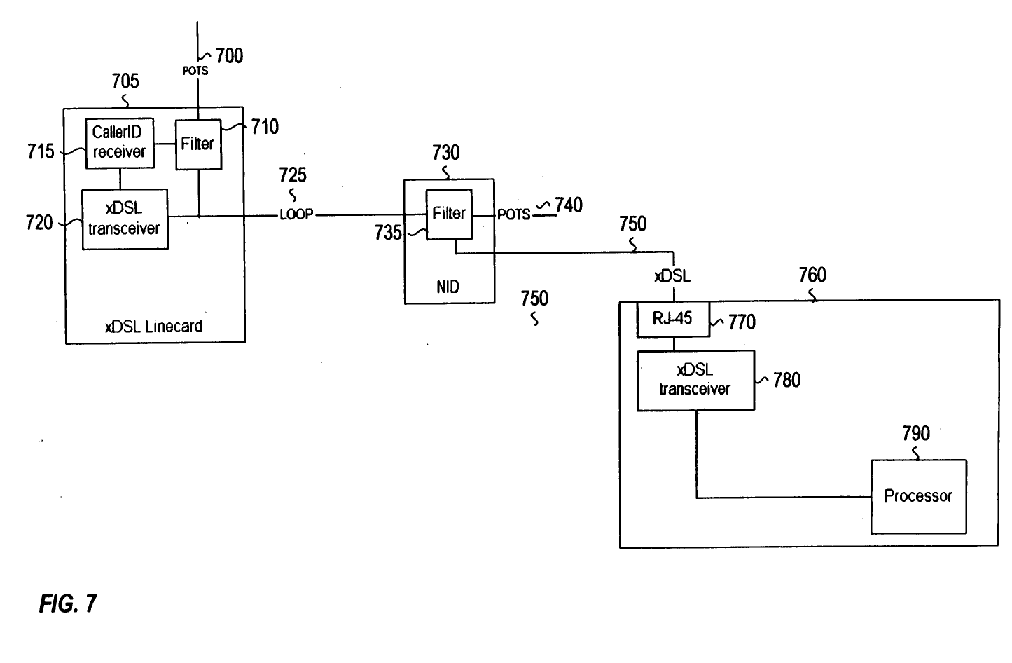

An alternative embodiment is to extract the caller ID data from the telephony signals upstream and transmit the caller ID data within the digital data stream. This embodiment would eliminate the need for a separate caller ID chip and telephone connection for each RG, and would eliminate the need to wire the telephone line to the RG. FIG. 7 illustrates an exemplary block diagram of the caller ID being extracted upstream and provided with the xDSL digital transport stream. POTs signals 700 are received at an xDSL line card 705. The line card 705 includes a filter 710 that prevents xDSL data from being transmitted upstream to the voice (i.e., PSTN) network. The POTs signals are then provided to a caller ID receiver 715 that extracts the caller ID data from the POTs signals. The caller ID data is then provided to an xDSL transceiver 720 that implants the caller ID within the xDSL stream and transmits the telephony and xDSL signals (including caller ID) to the location. At the location, the NID 730, has a filter 735 that segregates the telephony services and the xDSL services. The telephony services are transmitted over the POTs lines 740 and the xDSL services are transmitted over the xDSL line 750 to the RG 760.

The xDSL line 750 is connected to an RJ-45 connector 770 and the xDSL signals are received by the xDSL transceiver 780 that forwards all the xDSL data including the caller ID data to the processor 790 for processing.

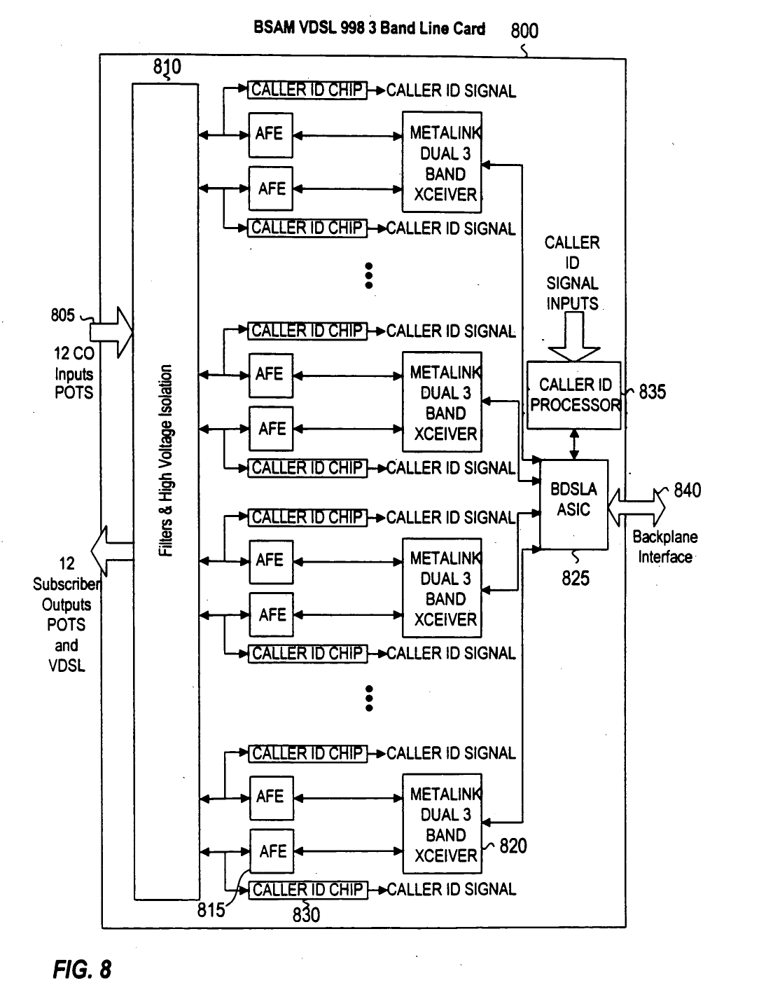

According to one embodiment, the caller ID is extracted from the telephony signals at the BSAM. FIG. 8 illustrates an exemplary embodiment of a BSAM line card 800 that can be used to extract caller ID data from the POTS signals 805 received from a central office. As previously discussed each line card can provide 12 xDSL lines and the underlying POTS services. The POTS signals 805 are initially provided to filters and high voltage isolation 810. Each POTS signal 805 is then provided to a separate circuit for each POTS/xDSL line. Each circuit includes an analog front end (AFE) 815 to convert the analog telephony signals to digital signals. The digital POTS signals are then provided to a transceiver 820 that transmits them to ASIC 825. The POTS signals 805 are also provided to a caller ID chip 830 that extracts the caller ID data and provides the caller ID data to a caller ID processor 835 that organizes the caller ID for each of the 12 POTS lines. The caller ID processor 835 provides the caller ID data to the ASIC 825. The ASIC 825 also receives xDSL data over a backplane interface 840. The ASIC 825 prepares all the data (xDSL, POTS, and caller ID) for transmission over twisted wire pair to the subscriber. The caller ID data is put in an ATM (IP or other packet schemes) packet and is transported in the xDSL data stream that is overlaid over the POTS signals. The ASIC 825 provides the combined data to the transceiver 820 that passes it through the AFE 815 to convert the digital signals to analog signals. The signals (POTS, xDSL) then pass through the filter 810 prior to be transmitted to the appropriate subscribers over the twisted wire pair.

The extraction of the caller ID is in no way limited by the illustrated embodiment of FIG. 8. In an alternative embodiment, a caller ID chip 830 function may be incorporated into the caller ID processor 835 or the ASIC 825. The transport stream may be ADSL, ADSL+, VDSL or other protocols know to those of ordinary skill in the art. The packetization stream used to transport the data to the subscribers may be ATM, IP or other packetization schemes that would be known to those or ordinary skill in the art. The extraction could also be performed in the USAM by using caller ID chips, a caller ID process, the ASIC or other mean that would be well known to those of ordinary skill in the art. The caller ID could also be extracted at the BDT. Again a caller ID chip could be provided for each line or other processing (i.e., ASIC) could be provided to extract the caller ID and embed it within the digital (xDSL) transport stream.

If the caller ID is embedded within the digital transport stream the RG will be configured such that the data can be taken from the digital stream and presented to the subscriber overlaid over video (i.e., on TV or PC). As one of ordinary skill in the art would recognize in light of this specification, extracting the caller ID upstream within the broadband network eliminates the need for receiving the POTS line at the RG. As no POTS line is required the caller ID data can also be presented on xDSL systems that do not support video but only support data. These embodiments utilize an Etherset (basically an xDSL modem) as the interface between the broadband network and the PC. The Etherset would be able to extract the caller ID data from the digital stream and present it on the PC.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. In a telecommunications system, a method of transmitting caller identification data to residential equipment within a digital transport stream, the method comprising:
receiving telephony signals that include caller identification data;
extracting the caller identification data from the telephony signals;
embedding the caller identification data in the digital transport stream; and
transmitting the digital transport stream to the residential equipment.

2. The method of claim 1, further comprising
extracting the caller identification from the transport stream; and
displaying the caller identification data.

3. The method of claim 1, wherein the digital transport stream includes at least some subset of voice, data, and video.

4. The method of claim 1, wherein said receiving includes receiving the telephony signals from a Public Switched Telecommunications Network (PSTN).

5. The method of claim 1, wherein said receiving includes receiving the telephony signals at a central office.

6. The method of claim 1, wherein said extracting includes extracting the caller identification data at a central office.

7. The method of claim 1, wherein said extracting is performed by a broadband digital terminal.

8. The method of claim 1, wherein said embedding includes embedding the caller identification data at a central office.

9. The method of claim 1, wherein said embedding is performed by a broadband digital terminal.

10. The method of claim 1, wherein receiving includes receiving the telephony signals from a central office.

11. The method of claim 1, wherein said receiving includes receiving the telephony signals at a remote terminal.

12. The method of claim 11, wherein the remote terminal is a universal service access multiplexor.

13. The method of claim 11, wherein the remote terminal is a broadband service access multiplexor.

14. The method of claim 1, wherein said extracting includes extracting the caller identification data at a remote terminal.

15. The method of claim 1, wherein said extracting is performed by a caller identification intercept circuit.

16. The method of claim 1, wherein said extracting is performed by an application specific integrated circuit (ASIC).

17. The method of claim 1, wherein said embedding includes embedding the caller identification data at a remote terminal.

18. The method of claim 1, wherein said embedding is performed by an application specific integrated circuit (ASIC).

19. The method of claim 1, wherein said transmitting includes transmitting the digital transport stream to the residential equipment over twisted wire pairs.

20. The method of claim 1, wherein said transmitting includes transmitting the digital transport stream to the residential equipment over coaxial cable.

21. The method of claim 1, wherein the digital transport stream is a digital subscriber line (xDSL) transport stream.

22. The method of claim 21, wherein the digital subscriber line (XDSL) transport stream is a VDSL transport stream.

23. The method of claim 21, wherein the digital subscriber line (xDSL) transport stream is an ADSL plus transport stream.

24. The method of claim 1, wherein said transmitting includes transmitting the digital transport stream utilizing a packetization protocol.

25. The method of claim 24, wherein the packetization protocol is asynchronous transfer mode (ATM)

26. The method of claim 24, wherein the packetization protocol is Internet protocol (IP).

27. The method of claim 1, wherein said extracting includes extracting the caller identification within the residential equipment.

28. The method of claim 27, wherein the residential equipment is a residential gateway.

29. The method of claim 27, wherein the residential equipment is an etherset.

30. In a telecommunications system, a system capable of transmitting caller identification data to residential equipment within a digital transport stream, the system comprising:
a receiver to receive telephony signals that include caller identification data;
means to extract the caller identification data from the telephony signals;
means to embed the caller identification data in the digital transport stream; and
a transmitter to transmit the digital transport stream to the residential equipment.

31. The system of claim 30, wherein said receiver is located in a central office and receives the telephony signals from a Public Switched Telecommunications Network (PSTN).

32. The system of claim 30, wherein said receiver is located in a remote terminal and receives the telephony signals from a central office.

33. The system of claim 30, wherein said means to extract is located in a central office.

34. The system of claim 30, wherein said means to extract is located in a broadband digital terminal.

35. The system of claim 30, wherein said means to extract is located in a remote terminal.

36. The system of claim 35, wherein the remote terminal is a universal service access multiplexor.

37. The method of claim 35, wherein the remote terminal is a broadband service access multiplexor.

38. The system of claim 30, wherein said means to extract is a caller identification intercept circuit.

39. The system of claim 30, wherein said means to extract is an application specific integrated circuit (ASIC).

40. The system of claim 30, wherein said means to embed is located in a central office.

41. The system of claim 30, wherein said means to embed is located in a remote terminal.

42. The system of claim 30, wherein means to embed is an application specific integrated circuit (ASIC).

43. The system of claim 30, wherein said transmitter transmits the digital transport stream to the location over twisted wire pairs.

44. The system of claim 30, wherein said transmitter transmits the digital transport stream to the location over coaxial cable.

45. The system of claim 30, wherein the digital transport stream is a digital subscriber line (xDSL) transport stream.

46. The system of claim 45, wherein the digital subscriber line (XDSL) transport stream is a VDSL transport stream.

47. The system of claim 45, wherein the digital subscriber line (xDSL) transport stream is an ADSL plus transport stream.

48. The system of claim 30, wherein said transmitter transmits the digital transport stream utilizing a packetization protocol.

49. The system of claim 48, wherein the packetization protocol is asynchronous transfer mode (ATM)

50. The system of claim 48, wherein the packetization protocol is Internet protocol (IP).

51. The system of claim 30, further comprising residential equipment to receive the digital transport stream and extract the caller identification data therefrom.

52. The system of claim 51, wherein the residential equipment is a residential gateway.

53. The system of claim 51, wherein the residential equipment is an etherset.

54. A residential gateway for receiving a digital stream from a telecommunications network and extracting and distributing video signals to a plurality of televisions locatable within at least two separate locations in a residential environment and extracting caller identification signals and distributing them to at least one display device connected to the residential gateway, said residential gateway comprising:
a plurality of remote control devices, associated with a respective one of the plurality of televisions, to transmit channel select commands;
a network interface module to receive the digital stream, wherein the digital stream is capable of including video signals corresponding to the channel select commands and caller identification data associated with incoming telephony calls;
means for constructing at least one series of video packets from the received video signals;
a plurality of video processors for decoding the at least one series of video packets to produce at least one television signal;
a video packet bus for transporting the at least one series of video packets to said plurality of video processors; and
means for extracting the caller identification data from the digital stream and overlaying it on a display device connected to the residential gateway.
